(19) United States
(12) Patent Application Publication
(10) Pub. No.: US 2010/0058314 A1
(43) Pub. Date: Mar. 4, 2010

(54) Computer System and Related Method of Logging BIOS Update Operation

(76) Inventor: Chin-Yu Wang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/551,573

(22) Filed: Sep. 1, 2009

(30) Foreign Application Priority Data
Sep. 3, 2008 (TW) 097133709

(51) Int. Cl. G06F 9/44; G06F 12/00

(52) U.S. Cl. 717/168; 711/103; 713/2

(57) ABSTRACT

In order to record a BIOS update operation, a non-volatile memory space is configured in a computer system. When the BIOS of the computer are updated, an update log is generated and stored into the non-volatile memory space when updating the BIOS.

### BACKGROUND OF THE INVENTION

1. Field of the Invention

The present invention relates to a computer system and related method for updating a Basic Input/Output System (BIOS), and more particularly to a computer system and related method capable of logging an update operation of the BIOS.

2. Description of the Prior Art

When booting up a computer system, a BIOS (Basic Input/Output System) takes charge of hardware initiation, hardware function detection, as well as loading an operating system. In general, the BIOS is stored in a non-volatile memory that can retain stored information even when not powered, and a first instruction that a central processing unit (CPU) tries to execute when the system is powered up or reset is addressed to the memory location where the BIOS is stored, so that the boot process of the computer system can be performed.

When the computer system is turned on, the BIOS are first extracted to a main memory of the computer system for execution of Power on Self-Test (POST) and a bootstrap program. The POST program ensures that basic components of the computer system, such as keyboards, disc devices and input/output ports, for example, are operating correctly; and the bootstrap program loads boot code into the main memory to boot an operating system. In addition, the BIOS can also provide an interrupt daemon for the operating system/application programs, and records default settings of the computer system, which are well known in the art of computer systems, and thus detailed description is not given herein.

Previously, the BIOS program has been stored in a Read-Only-Memory (ROM) and could not be changed. However, with increasing complexity of computer systems and upgrade frequency of peripheral hardware devices, the BIOS program must be updated constantly to support new hardware features. Thus, computer manufacturers have begun storing the BIOS program in an Electrically-Erasable Programmable Read-Only Memory (EEPROM) such as a flash memory, for example. The great benefit of this is that the flash memory can be programmed to update the BIOS, so as to relieve users of the tedious necessity of physically replacing hardware.

However, during an update operation of the BIOS program, improper handling or suspension will easily cause damage to the BIOS program, leading to a totally inoperative computer system. Since the update process of the BIOS is not recorded, computer makers have no way to know or analyze the reasons for the failure of the BIOS update operation, resulting in a need for a great effort to strengthen the BIOS program.

### SUMMARY OF THE INVENTION

It is therefore an objective of the present invention to provide a computer system and related method capable of logging update operation of a Basic Input/Output System (BIOS) program.

According to the present invention, a computer system capable of logging update operation of a Basic Input/Output System (BIOS) program is disclosed. The computer system includes a non-volatile memory, a processor and an Electrically-Erasable Programmable Read-Only Memory (EEPROM). The processor is utilized for executing a program code to control the computer system. The EEPROM is coupled to the processor, and is utilized for storing the BIOS program. The BIOS program further includes an update program code, for updating the BIOS program; a burning program code, for burning the updated BIOS program into the EEPROM; and a logging program code, for generating an update log and storing the update log into the non-volatile memory when the burning program code is called by the update program code.

According to the present invention, a method for logging update operation of a Basic Input/Output System (BIOS) program is disclosed. The method includes steps of updating the BIOS program; and generating an update log and storing the update log into a non-volatile memory when updating the BIOS program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system capable of logging update operation of a BIOS program according to an embodiment of the present invention.

FIG. 2 illustrates an update log according to an embodiment of the present invention.

FIG. 3 is a schematic diagram of a process for logging BIOS update operation according to an embodiment of the present invention.

### DETAILED DESCRIPTION

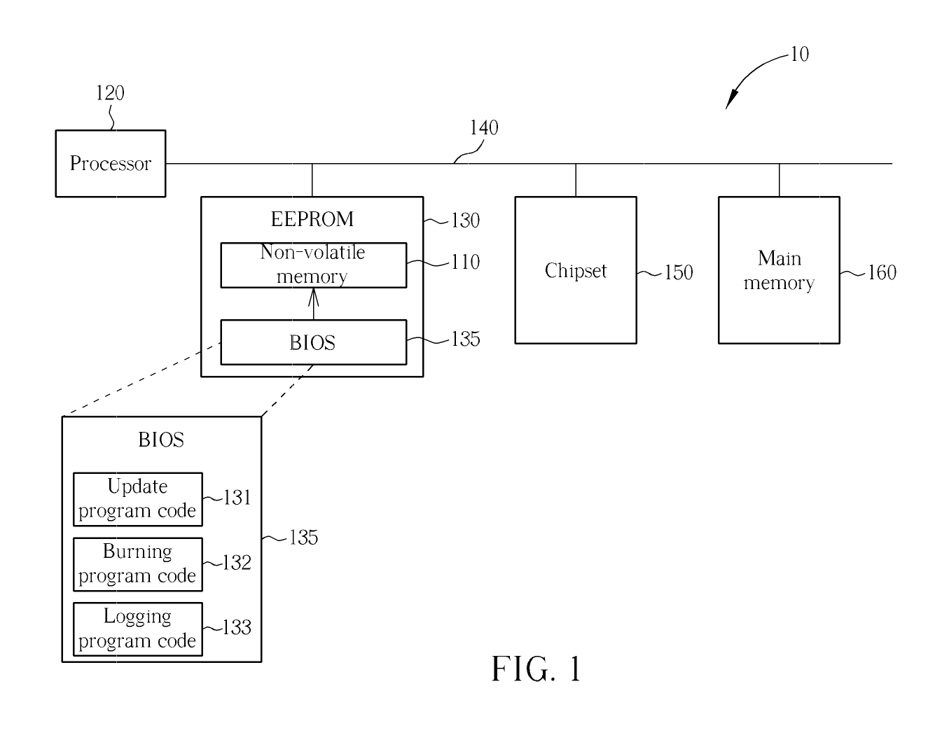

Please refer to FIG. 1. FIG. 1 is a functional block diagram of a computer system 10 capable of logging an update operation of a Basic Input/Output System (BIOS) according to an embodiment of the present invention. The computer system 10 mainly includes a non-volatile memory 110, a processor 120 and an Electrically-Erasable Programmable Read-Only Memory (EEPROM) 130. The processor 120 is utilized for executing a program code to control the computer system 10. The EEPROM 130, such as a flash memory, is coupled to the processor 120 through a system bus 140, and is utilized for storing a BIOS 135. In addition, the computer system 10 further includes a chipset 150 and a main memory 160, both of which are coupled to the processor 120 though the system bus 140 as well. The chipset 150 is used as a bridge for communicating with other peripheral hardware devices, while the main memory 160 is utilized for storing program code that the processor 120 may execute. Detailed operation of the computer system 10 is well-known by those skilled in the art, and thus is not narrated herein. Note that FIG. 1 merely illustrates necessary components related to the embodiment of the present invention and omits some components of the computer system 10.

In the embodiment of the present invention, the BIOS 135 further includes update program code 131, burning program code 132 and logging program code 133. The update program code 131 is utilized for updating the BIOS 135; the burning program code 132 is utilized for burning the updated BIOS 135 into the EEPROM 130; and the logging program code 133 is utilized for generating an update log and storing the update log into the non-volatile memory 110 when the burning program code 132 is called by the update program code 131.

Therefore, when the BIOS update operation fails, the update log stored in the non-volatile memory 110 can be read out to determine and analyze the reasons why the update operation cannot be completed, so as to be taken as references for repairing or strengthening the BIOS program.

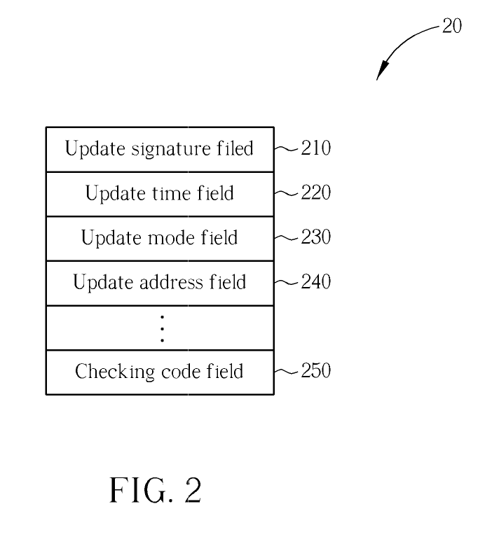

For example, please refer to FIG. 2, which illustrates an update log 20 according to an embodiment of the present invention. As shown in FIG. 2, the update log 20 can be realized in the form of a data structure, and includes a plurality of update information fields, such as an update signature filed 210, an update time field 220, an update mode field 230, an update address field 240 and a checking code field 250. The update signature filed 210 is utilized for recording whether the BIOS 135 is updated; the update time field 220 is utilized for recording update time of the BIOS 135; the update mode field 230 is utilized for recording an update mode of the BIOS 135 (e.g. how the BIOS 135 is updated); the update address field 240 is utilized for recording memory location of the updated BIOS 135; and the checking code field 250 is utilized for checking whether the update information fields are all correct.

Therefore, by means of the operation log 20, computer makers can obtain the update time, the update mode and the update address of the BIOS program, e.g. which utility is used to update the BIOS, or whether the BIOS is updated in an operating system environment/a BIOS environment, to determine and analyze the reasons for the failure of the BIOS update operation, so as to be references for repairing or strengthening the BIOS program.

Preferably, the above-mentioned non-volatile memory 110 can be configured inside the EEPROM 130. In this case, when the failed update operation of the BIOS 135 leads to system failure, the update log 20 can be read out by a memory access device (including software and hardware) in the embodiment of the present invention. Besides, the non-volatile memory 110 can also be formed inside a register of the chipset 150. In this case, when the failed update operation of the BIOS 135 leads to system failure, the EEPROM 130 can be replaced by another EEPROM with the BIOS program to boot up the computer system, so as to read out the update log 20 in the embodiment of the present invention.

Please note that the above embodiments are merely exemplary illustrations of the present invention, and that appropriate modifications can be made by those skilled in the art according to practical demands but not restricted herein. For example, the non-volatile memory 110 can also be allocated in a hard disc device (not shown in FIG. 1) coupled via the chipset 15. In such a situation, the logging program code 133 further outputs the update log 20 as a file and stores the file into a file system.

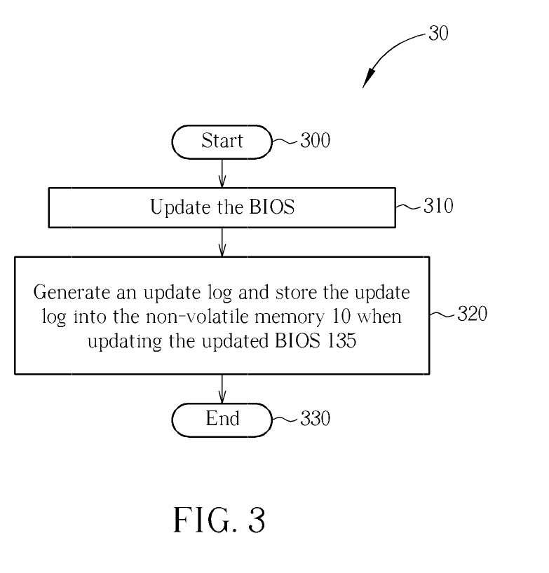

Please refer to FIG. 3. FIG. 3 is a schematic diagram of a process 30 for logging BIOS update operation according to an embodiment of the present invention. The process 30 is utilized for implementing the computer system 10, and includes the following steps:

Step 300: Start.

Step 310: Update the BIOS 135.

Step 320: Generate an update log and store the update log into the non-volatile memory 10 when updating the updated BIOS 135.

Step 330: End.

According to the process 30, when the computer system 10 updates the BIOS 135, an update log is generated and stored into the non-volatile memory 10 when updating the BIOS 135. Detailed operation of the process 30 is already described in the computer system 10, and not narrated again.

As mentioned above, the present invention utilizes the non-volatile memory to record the BIOS update operation in the computer system, so that when the BIOS update operation fails, the operation log stored in the non-volatile memory can be read out as a reference for repairing or strengthening the BIOS program.

Those skilled in the art will readily observe that numerous modifications and alterations of the device and method may be made while retaining the teachings of the invention.

What is claimed is:

1. A computer system capable of recording an update operation of a Basic Input/Output System (BIOS) program, the computer system comprising:
a non-volatile memory;
a processor for executing program code to control the computer system; and
an Electrically-Erasable Programmable Read-Only Memory (EEPROM) coupled to the processor for storing the BIOS program, the BIOS program comprising:
update program code for updating the BIOS program;
burning program code for burning the updated BIOS program into the EEPROM; and
logging program code for generating an update log and storing the update log into the non-volatile memory when the burning program code is called by the update program code.

2. The computer system of claim 1, wherein the update log comprises a plurality of update information fields, the plurality of update information fields comprising:
an update signature filed for recording whether the BIOS program is updated;
an update time field for recording update time of the BIOS program;
an update address field for recording a burning address of the updated BIOS program;
an update mode field for recording an update mode of the BIOS program; and
a checking code field for checking whether the pluralities of update information fields are all correct.

3. The computer system of claim 1, wherein the non-volatile memory is configured inside the EEPROM.

4. The computer system of claim 1, wherein the update log is read out by a memory access device when failed update operation of the BIOS leads to system failure.

5. The computer system of claim 1 further comprising a chipset, the non-volatile memory being configured inside the chipset.

6. The computer system of claim 1, wherein the EEPROM is replaced by another EEPROM with the BIOS program to boot up the computer system and to read out the update log when failed update operation of the BIOS leads to system failure.

7. The computer system of claim 1, wherein the logging program code is further utilized for generating a file according to the update log and storing the file into the non-volatile memory.

8. A method for logging update operation of a Basic Input/Output System (BIOS) program, the BIOS program being stored in an Electrically-Erasable Programmable Read-Only Memory (EEPROM), the method comprising:
updating the BIOS program; and
generating an update log and storing the update log into a non-volatile memory when updating the BIOS program.

9. The method of claim 8, wherein the update log comprises a plurality of update information fields, the plurality of update information fields comprising:
an update signature filed for recording whether the BIOS program is updated;
an update time field for recording update time of the BIOS program;
an update address field for recording a burning address of the updated BIOS program;
an update mode field for recording an update mode of the BIOS program; and
a checking code field for checking whether the pluralities of update information fields are all correct.

10. The method of claim 8, wherein the non-volatile memory is formed inside the EEPROM.

11. The method of claim 8 further comprising:
reading out the update log through a memory access device when failed update operation of the BIOS program leads to system failure.

12. The method of claim 8, wherein the non-volatile memory is formed inside a chipset.

13. The method of claim 12 further comprising:
replacing the EEPROM by another EEPROM with the BIOS program to boot up a computer system and to read out the update log when failed update operation of the BIOS program leads to system failure.

14. The method of claim 8 further comprising:
generating a file according to the update log and storing the file into the non-volatile memory.
